(19) United States
(12) Patent Application Publication
(10) Pub. No.: US 2003/0034982 A1
(43) Pub. Date: Feb. 20, 2003

(54) Device for graphically processing video objects

(76) Inventors: Jacky Talayssat, Chateauneuf (FR); Jean Gobert, Maisons-Alfort (FR)

Correspondence Address: U.S. Philips Corporation, 580 White Plains Road, Tarrytown, NY, 10591, US

(21) Appl. No.: 10/207,552

(22) Filed: Jul. 29, 2002

(30) Foreign Application Priority Data
Aug. 2, 2001 (FR) 0110372

(51) Int. Cl. G09G 5/00

(52) U.S. Cl. 345/582

(57) ABSTRACT

The present invention relates to a device for graphically processing video objects containing texture data, said device comprising a filtering circuit (11) for subsampling a video object, and a video object composition unit (13) for applying texture data of the video object to a graphical form via a geometric transformation. The video object composition unit calculates a subsampling factor using parameters of the geometric transformation, said subsampling factor then being used by the filtering circuit to subsample the video object. The video object composition unit then applies the subsampled video object to the graphical shape with a view to displaying a visual scene on the screen.

### FIELD OF THE INVENTION

The present invention relates to a device for graphically processing video objects containing texture data, said device comprising a filtering circuit able to subsample the video objects, and a video object composition unit able to apply texture data to a graphical form via a geometric transformation.

It finds its application in digital apparatus intended to compose video objects such as for example video decoders, 3D graphical accelerators, video game consoles, digital personal assistants or mobile telephones.

### BACKGROUND OF THE INVENTION

Graphical accelerators for processing video objects comprising texture data are known from the document entitled “Computer Graphics: Principles and Practice” by Foley et al., 1990. The operating principle of said graphical accelerators is described more particularly on pages 815-835 of this work and is illustrated in FIG. 1. The graphical accelerator generally comprises a filtering circuit FIL (11) using the concept of “MIP maps” for subsampling a video object at an original resolution (101) according to various levels. The video object at the original resolution is a set with two dimensions x and y of pixels. A video object of the first resolution level thus corresponds to a spatial subsampling of the video object at the original resolution with a resolution divided by two according to each of the directions x and y, and thereby contains one quarter of the pixels of the video object at the original resolution. The operation is iterated at each level, so that a video object at a new current resolution k has a resolution divided by two in each of the directions x and y with respect to the video object of the immediately higher resolution level k−1. In this way a set (100) of versions (101 to 104) of the video object is obtained, referred to as MIP-maps, each version having a different resolution. This set of versions of the video object is stored in a memory (10) via a system bus (12).

The graphical accelerator of the state of the art also comprises a video object composition unit (13) with a view to displaying a visual scene on a screen (14), the texture data of a video object being intended to fit in a graphical shape (105), a polygon for example. The function of the video object composition unit is to convert the video object in order to adjust it to the dimensions of the graphical shape by virtue of a geometric transformation. For this purpose, it determines in the set of versions of the video object one or two versions of the video object where the resolution level or levels are closest to the resolution of the screen on which the video object is to be displayed within the graphical shape. The video object composition unit then performs bilinear interpolations using 4 pixels of a video object with a predetermined resolution level or trilinear interpolations, that is to say, linear interpolations between two bilinear interpolations on two video objects with different resolution levels.

A graphical accelerator of this type thus makes it possible to generate a set of video versions of a video object in advance, a version of the video object at its original resolution and versions of the video object subsampled at various resolution levels, said versions of the video object being stored statically in a memory in order to be used subsequently by the video object composition unit. However, though this graphical accelerator can be used with simple natural textures, it does not make it possible to execute an application in real time using video objects containing data of complex texture which are moreover periodically renewed, typically every 1/25^{th} or 1/30^{th} of a second. With such texture data, a subsampling of the video object according to different resolution levels will be very expensive in terms of bandwidth because of the many exchanges it would require between the various circuits, via the system bus.

### SUMMARY OF THE INVENTION

It is an object of the present invention to propose a device for the graphical processing of texture data for processing complex texture data in real time.

To this end, the graphical processing device is characterized in that the video object composition unit is able to calculate a subsampling factor from parameters of the geometric transformation, the filtering circuit is able to subsample the video object according to the subsampling factor, and the video object composition unit is able to apply the video object thus subsampled to the graphical shape.

Such a graphical accelerator thus makes it possible to compose a visual scene using a video object subsampled as needed rather than, as is described in the state of the art, from a set of versions of a video object subsampled at different resolution levels. The use of the bandwidth is thereby optimized.

### BRIEF DESCRIPTION OF THE DRAWINGS

The invention will be further described with reference to examples of embodiment shown in the drawings to which, however, the invention is not restricted:

FIG. 1 illustrates the operating principle of a graphical accelerator for processing video objects according to the state of the art, and

FIG. 2 illustrates the operating principle of a graphical accelerator for processing video objects according to the invention.

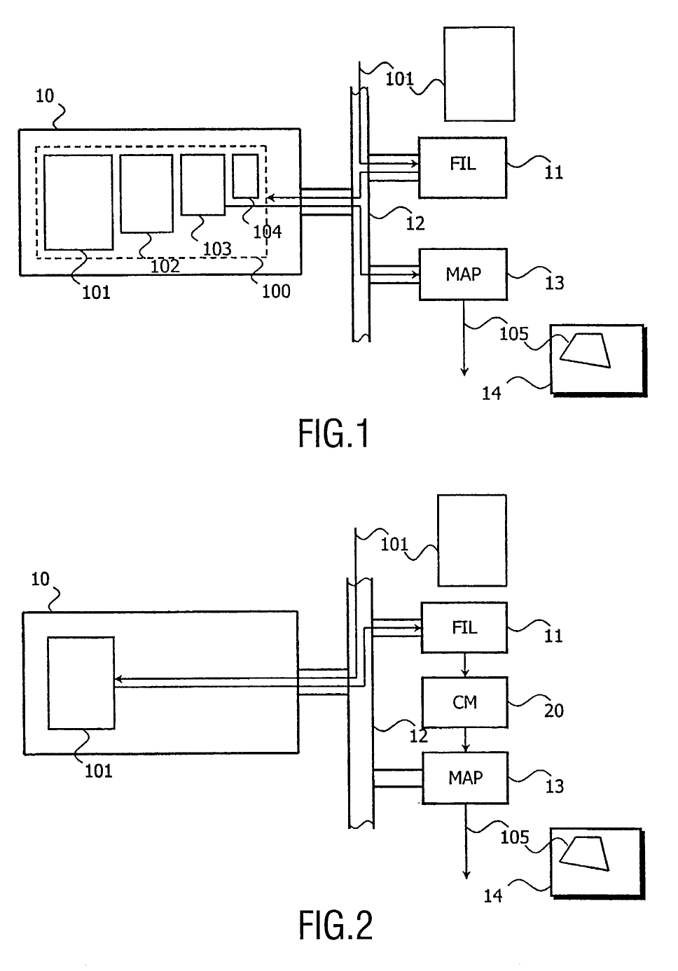

### DESCRIPTION OF PREFERRED EMBODIMENTS

The present invention was developed in the context of a graphical accelerator for displaying video objects coming from a sequence of images coded according to the standard MPEG-4. It applies to any device for the graphical processing of video objects containing texture data.

FIG. 2 illustrates the operating principle of a graphical accelerator according to the invention. The graphical accelerator comprises a memory (10) which stores a video object at an original resolution. It also comprises a filtering circuit (11) which, unlike the state of the art, will not a priori generate the set of versions of the video object. Finally, the graphical accelerator comprises a video object composition unit (13) able to apply texture data of the video object to a graphical shape via a geometric transformation. For the purpose of fitting the video object in the graphical shape, the graphical accelerator is able to perform the following operations:

The video object composition unit first of all calculates a subsampling factor from parameters of the geometric transformation. For example, if the geometric transformation is a zoom, the coordinates (U,V) of the subsampled video object are determined from the coordinates (u,v) of the video object at its original resolution according to the following system of equations:

$$\{ \begin{matrix}U = a u + bv + c \\ V = du + ev + f\end{matrix}$$

where a, b, c, d, e and f are constants. If a=⅕, e=¼ and b=c=d=f=0, the subsampling factor is 5 in the horizontal direction and 4 in the vertical direction. In the example given above, the zoom is fixed for reasons of simplicity of the disclosure but it will be clear to a person skilled in the art that the geometric transformation is more generally a perspective, where the local zoom factor is variable.

The filtering circuit is able to receive the video object at its original resolution via a system bus (12), and to subsample said video object according to the previously calculated subsampling factor. For this purpose, the filtering circuit uses for example a linear filter whose coefficients are determined by the local zoom factor. In the preferred embodiment, the filtering circuit is able to supply a subsampled video object to an intermediate memory CM (20).

The intermediate memory is able to store the subsampled video object temporarily. The intermediate memory is for example a cache memory. Such a cache memory reduces the complexity of the graphical processing device as well as the bandwidth, the subsampled pixels being read repeatedly by the video object composition unit for the final interpolation filtering. It also allows functioning in pipeline mode, the video object composition unit using a current subsampled video object, while the filtering circuit prepares the subsampled version of the next video object. According to another embodiment, the graphical processing device does not have any intermediate memory and the subsampling takes place in a stream as required by the video object composition unit.

The video object composition unit is able to apply the subsampled video object to the graphical shape where a visual scene is composed.

Thus the subsampled video object is produced only on demand and the data passing over the system bus are minimized, thereby reducing the bandwidth compared with the state of the art.

FIG. 2 illustrates the invention rather than limiting it. There are many ways coming within the scope of the present invention for implementing the functions described above by means of circuits and buses. For example, the intermediate memory (20) can be connected directly to the bus. It then does not require a dedicated interface between the filtering circuit (11) on the one hand and the video object composition unit (13) on the other.

The graphical processing device can be any type of digital apparatus intended to compose video objects, such as for example a video decoder, a 3D graphical accelerator, a video game console, a digital personal assistant or a mobile telephone.

No reference sign between parentheses in the present text should be interpreted limitingly. The verb “comprise” and its conjugations must also be interpreted in a broad fashion, that is to say, as not excluding the presence not only of elements or steps other than those listed after the verb, but also a plurality of elements or steps already listed after said verb and preceded by the word “a” or “an” or “one”.

1. A device for graphically processing video objects containing texture data, said device comprising:
a filtering circuit (11) able to subsample a video object, and
a video object composition unit (13) able to apply texture data of the video object to a graphical form via a geometric transformation, said device being characterized in that:
the video object composition unit is able to calculate a subsampling factor from parameters of the geometric transformation,
the filtering circuit is able to subsample the video object according to the subsampling factor, and
the video object composition unit is able to apply the subsampled video object to the graphical shape.

2. A device for graphically processing video objects as claimed in claim 1, characterized in that it also comprises an intermediate memory (20) able to temporarily store the subsampled video object issuing from the filtering circuit (11) and to supply said subsampled video object to the video object composition unit (13).
